(19) United States
(12) Patent Application Publication
(10) Pub. No.: US 2015/0098105 A1
(43) Pub. Date: Apr. 9, 2015

(54) MANAGEMENT APPARATUS AND MANAGEMENT METHOD OF IMAGE FORMING APPARATUS

(71) Applicants: Kabushiki Kaisha Toshiba, Tokyo (JP); Toshiba Tec Kabushiki Kaisha, Tokyo (JP)

(72) Inventor: Koji Yamaki, Tagata Shizuoka (JP)

(21) Appl. No.: 14/506,064

(22) Filed: Oct. 3, 2014

(30) Foreign Application Priority Data
Oct. 8, 2013 (JP) 2013-210886
Aug. 29, 2014 (JP) 2014-175072

(51) Int. Cl. G06F 3/12; H04N 1/00

(52) U.S. Cl. CPC G06F 3/1221; H04N 1/00896; G06F 3/1286; G06F 3/1229; H04N 2201/0094
USPC 358/1.14

(57) ABSTRACT

According to an embodiment, a management apparatus of image forming apparatuses includes a calculation unit and a setting unit. The calculation unit calculates a power consumption amount of each image forming apparatus based on log information acquired from a plurality of the image forming apparatuses and compares the calculated power consumption amounts with reference power consumption amounts. The setting unit sets a sleep timer value for each image forming apparatus based on a result of the comparison.

### CROSS-REFERENCE TO RELATED APPLICATION

This application is based upon and claims the benefit of priority from Japanese Patent Application No. 2013-210886, filed on Oct. 8, 2013; and Japanese Patent Application No. 2014-175072, filed on Aug. 29, 2014; the entire contents of which are incorporated herein by reference.

### FIELD

Embodiments described herein relate generally to a management apparatus and a management method of image forming apparatuses that integrally manage a plurality of the image forming apparatuses and reduce the power consumption of each of the image forming apparatuses.

### BACKGROUND

Conventionally, image forming apparatuses, for example, digital multifunction apparatuses called multi-function peripherals (MFP) are practically used. Such a digital multifunction apparatus includes a scanner and a printer. The scanner scans a document and processes image data acquired through the scanning process by using an image processing unit. The printer prints an image, for example, on a sheet based on the image data.

In addition, some of recent digital multifunction apparatuses have not only the copying function and the scanning function but also a facsimile function using a public line. Furthermore, some digital multifunction apparatuses have a plurality of functions such as a function for being linked to an external personal computer and the like by being connected to a network, receiving image data to be printed from the external computer, and printing the image data and the like.

In order to reduce the power consumption, various measures are taken for the digital multifunction apparatuses described above. For example, as a measure for reducing the power consumption, there is a method in which the digital multifunction apparatus transits to a power-saving mode such as a sleep state when a predetermined time elapses without any user's operation for the digital multifunction apparatus.

In addition, as a measure tor reducing the power consumption, a measure is known in which the operating rate of each of a plurality of image forming apparatuses is calculated, and the transition to a power-saving mode is controlled in accordance with the operating rates. However, the conventional measure described above is for reducing the power consumption of individual image forming apparatuses but is not for integrally managing the power consumption of the plurality of image forming apparatuses. For example, it has been difficult for a section using a plurality of image forming apparatuses to integrally manage the power consumption of the plurality of image forming apparatuses.

### BRIEF DESCRIPTION OF THE DRAWINGS

FIG. 1 is a diagram that illustrates the network configuration of a power management system of image forming apparatuses according to a first embodiment.

FIG. 2 is a block diagram that illustrates the configuration of an image forming apparatus according to the first embodiment.

FIG. 3 is a block diagram that illustrates a management apparatus of image forming apparatuses according to the first embodiment.

FIG. 4 is a flowchart that illustrates the power management operation of the management apparatus of linage forming apparatuses according to the first embodiment.

FIG. 5 is a flowchart that illustrates the power management operation of a management apparatus of image forming apparatuses according to a second embodiment.

### DETAILED DESCRIPTION

According to an embodiment, a management apparatus of image forming apparatuses includes: an information collecting unit, a calculation unit, a setting unit, and a management unit. The information collecting unit collects a plurality of pieces of log information that represent the operating statuses of the image forming apparatuses through a network. The calculation unit calculates power consumption amounts of the image forming apparatuses during a period set in advance based on the collected log information. The setting unit compares a reference power consumption amount with the calculated power consumption amounts. The setting unit sets a sleep timer value for each of the plurality of image forming apparatuses based on a result of the comparison. The sleep timer value described above is a predetermined elapse time until the image forming apparatus transits to a power-saving mode after an operation unit of the image forming apparatus receives a user's operation tor the last time. The management unit transmits the sleep timer value set by the setting unit to the corresponding image forming apparatus through the network.

Hereinafter, embodiments will be further described with reference to the drawings. Like reference numerals in the drawings denote like elements.

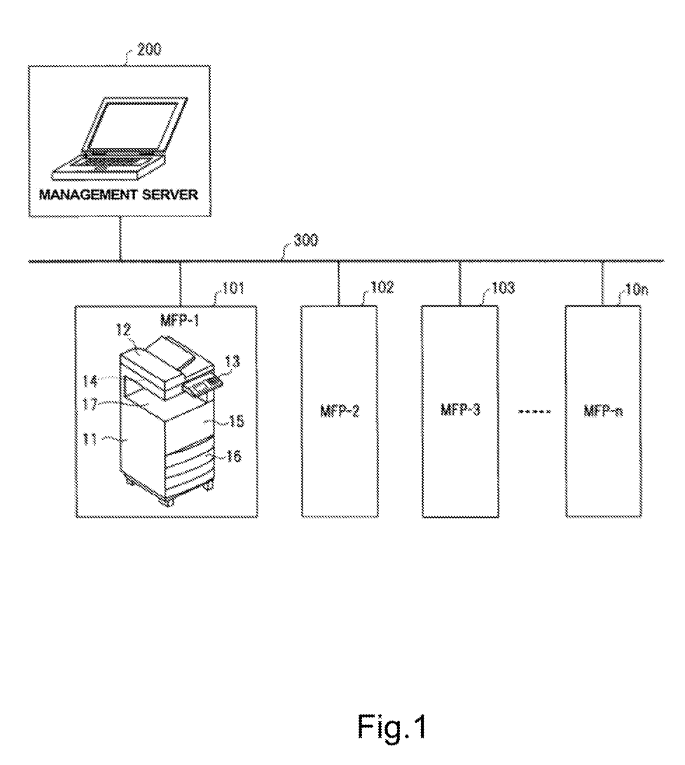

A first embodiment will be described with reference to FIG. 1. FIG. 1 is a diagram that illustrates the network configuration of a power management system of image forming apparatuses according to the first embodiment.

As illustrated in FIG. 1, the power management system includes a plurality of image forming apparatuses 101, 102, . . . , 10n and a management server 200. The plurality of image forming apparatuses 101, 102, . . . , 10n and the management server 200 are interconnected through a network 300. The network 300 is configured by a local area network (LAN) or the like. The image forming apparatuses 101, 102, . . . , 10n, for example, are digital multifunction apparatuses called multi-function peripherals (MFPs). In FIG. 1, the digital multifunction apparatuses are respectively denoted by MFP-1, MFP-2, . . . , MFP-n. The management server 200 is a management apparatus of the MFPs that centrally manages the operation modes of the MFPs 101, 102, . . . , 10n and operates each MFP in a power saving manner.

The MFPs 101, 102, . . . , 10n have the same configuration. The configuration of the MFPs 101, 102, . . . , 10n will be described with the MFP 101 being the representative thereof. As illustrated in FIG. 1, the MFP 101 includes an auto document feeder (ADF) 12 and an operation unit 13. On the upper side of a main body 11 of the MFP 101, a document stand is disposed. The ADF 12 is disposed so as to be freely opened or closed on the document stand. The ADF 12 conveys a document to a scanning position for the scanner 14. The operation unit 13 is disposed on the upper side of the main body 11. The operation unit 13, as will be described later, includes various operation keys and a touch-panel-type display.

As illustrated in FIG. 1, the MFP 101 includes a scanner 14, a printer 15, and a plurality of cassettes 16. The scanner 14 is disposed on the lower side of the ADF 12 inside the main body 11. The scanner 14 scans a document transmitted by the ADF 12 or a document placed on the document stand, thereby generating image data. The printer 15 is disposed in a center portion inside the main body 11. The printer 15 includes the plurality of cassettes 16. The plurality of cassettes 16 are disposed on the lower side of the main body 11. The plurality of cassettes 16 house various sizes of sheets.

The printer 15 prints an image on a sheet, for example, using electrophotography. The printer 15, for example, includes: a photosensitive drum, a laser exposure unit, a fixing unit, a sheet discharging unit, and the like. The printer 15 processes the image data generated by the scanner 14 or image data generated by a personal computer (PC) or the like and transfers a toner image on a sheet from the photosensitive drum. The printer 15 conveys the sheet onto which the toner image has been transferred to the fixing unit. The fixing unit, for example, includes a heating roller and a pressing roller. The heating roller and the pressing roller are arranged so as to face each other. The fixing unit fixes a toner image, which has been transferred to a sheet, to the sheet try causing the sheet to pass between the pressing roller and the pressing roller. The sheet discharging unit holds a sheet, to which an image (toner image) has been fixed and discharged outside the main body.

The management server 200 controls the operation modes of the MFPs 101, 102, . . . , 10n through the network 300. In addition, by controlling the operation modes of the MFPs 101, 102, . . . , 10n, the management server 200 takes the role of operating the MFPs 101, 102, . . . , 10n in a power saving manner.

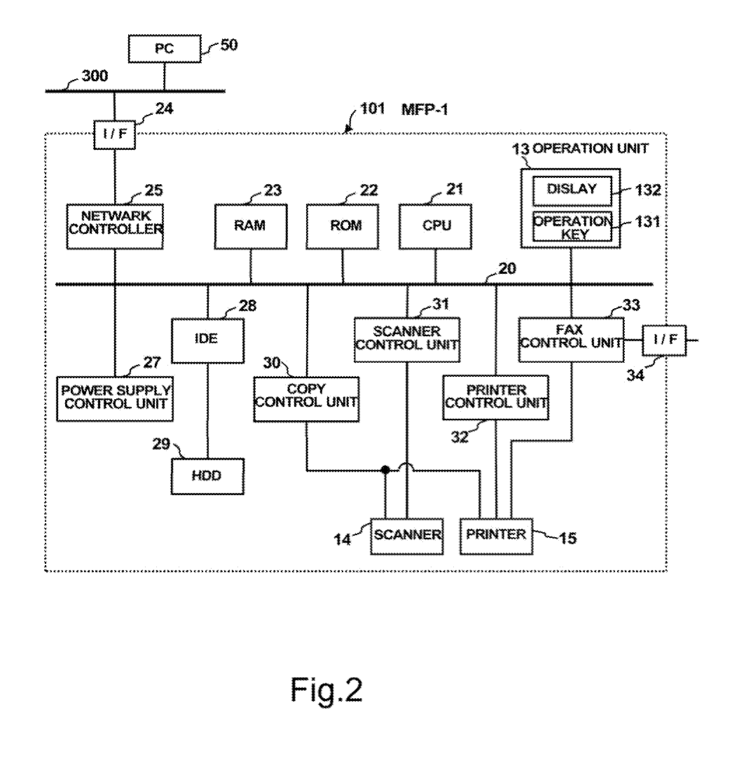

Hereinafter, the configuration for controlling the operations of the MFP 101 and the MFPs 102, 103, . . . , 10n will be described with reference to FIG. 2. Since the MFP 101 and MFPs 102, 103, . . . , 10n have the same configuration, the MFP 101 will be described as the representative thereof. FIG. 2 is a block diagram that illustrates the configuration of the MFP 101.

The MFP 101 includes: a central processing unit (CPU) 21; a peripheral component interconnect (PCI) bus 20; a read only memory (ROM) 22; and a random access memory (RAM) 23. The CPU 21 configures a control unit. The CPU 21 is connected to the PCI bus 20. The ROM 22 and the RAM 23 are connected to the PCI bus 20. The ROM 22 stores various control program data that are necessary to the operation of the MFP 101 therein. The RAM 23 stores control information at the time of the operation of each unit of the MFP 101.

The operation unit 13 is connected to the PCI bus 20. The operation unit 13 includes an operation key 131 and a display 132. The operation key 131 includes various keys that are used for setting the operation condition. More specifically, the operation key 131, for example, includes a start key, numeric keys, a print key, a setting/registration key, and the like. The display 132, for example, is a liquid crystal display. The liquid, crystal display includes a back light. The display 132 performs various displays. The operation key 131 and the display 132 receive a user's operation. The operation unit 13 inputs user's various instructions in accordance with the reception of user's operations for the operation key 131 and the display 132.

The MFP 101 includes a network interface (I/F) 24 and a network controller 25. The I/F 24 is connected to the PCI bus 20 through the network controller 25. The I/F 24 is connect able to a PC 50 or another external apparatus through the network 26. The network controller 25 controls data transmission/data reception performed between an external device through the I/F 24.

The MFP 101 includes a power supply control unit 27 and an integrated device electronics (IDE) 28. The power supply control unit 27 and the IDE 28 are connected to the PCI bus 20. The power supply control unit 27 supplies various power supply voltages to the units disposed inside the MFP 101. The power supply control unit 27 controls conduction states for the operation unit 13, the scanner 14, the printer 15, the hard disk drive (HDD) 29, and the like under the control of the CPU 21. More specifically, the power supply control unit 27 turns on/off the conduction of each unit or sets the conduction state of each unit to a power-saving mode such as a sleep state or a ready state.

The IDE 28 is an interface that is used for connecting the HDD 29 to the PCI bus 22. The HDD 29 stores image data at the time of performing a printing process using the printer 15. The CPU 21 controls storing of image data in the HDD 29 and reading of image data from the HDD 29.

The MFP 101 includes a copy control unit 30, a scanner control unit 31, a printer control unit 32, and a FAX control unit 33. The copy control unit 30, the scanner control unit 31, the printer control unit 32, and the FAX control unit 33 are connected to the PCI bus 20. The copy control unit 30 controls a copying function, a scanning function, and a file function. The copying function is a function for printing the image of a document on a sheet by using the printer 15 based on the image data of the document that is generated by the scanner 14. The scanning function is a function for generating image data of a document by scanning the document using the scanner 14. The file function is a function for scanning a document using the scanner 14 and storing the generated image data of the document in the PC 50.

The printer control unit 32 controls a printing function using the printer 15. The printing function, for example, includes a network printing function. The network printing function is a function for printing image data transmitted from an external device such as the PC 50. The FAX control unit 33 is connected to an interface 34 that transmits/receives data through a line (not illustrated in the figure).

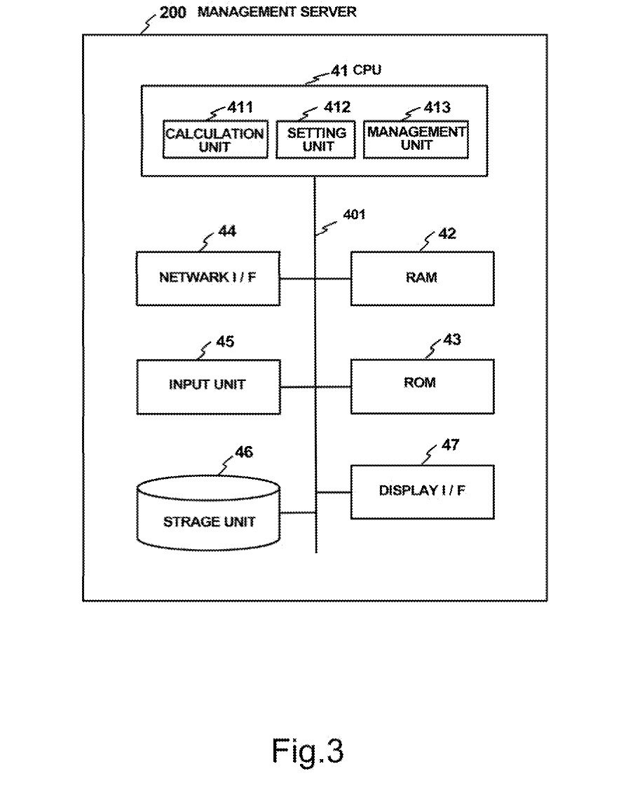

Hereinafter, the management server 200 that is the management apparatus of the MFP 101 and MFPs 102, 103, . . . , 10n will be described with reference to FIG. 3. FIG. 3 is a block diagram that illustrates the management server 200. The management server 200 is a terminal apparatus such as a personal computer (PC). The management server 200 includes: a CPU 41 that is a processor; a RAM 42; a ROM 43; a network interface (I/F) 44; an input unit 45; a storage unit 46; and a display I/F 47. The units described above are interconnected through a bus line 401. The CPU 41 includes a calculation unit 411, a setting unit 412, and a management unit 413.

The CPU 41 configures a computer and per forms overall control of the management server 200. The CPU 41 realizes various processing functions such as a function for operating the MFPs 101 to 10n in a power saving manner by executing a program stored in the ROM 43. The RAM 42 is a working memory. The ROM 43 stores a control program used for controlling basic operations of the management server 200, control data, and the like therein.

The network I/F 44 is an interface that is used for performing data communication with the MFPs 101 to 10n connected to the network 300. The input unit 45 includes a keyboard, a mouse, and the like. The input unit 45 receives a user's instruction using the keyboard, the mouse, and the like. In other words, the input unit 45 inputs various signals such as data and commands relating to user's instructions. The storage unit 46 is a storage device for storing data such as an HDD. The storage unit 46 stores the operation information of each MFP therein. The operation information includes information that represents the use status of the MFP. The information representing the use status includes information from which an operation (copy, print, FAX, or the like) performed by the MFP, a time when the operation is performed, and the number of times the operation is performed can be acquired. The information representing the use status, for example, includes information of a use frequency. In addition, the operation information includes information from which the power consumption amounts of the MFP can be acquired. More specifically, the operation information, for example, is log information that represents the operation state of the MFP. The display I/F 47 is an interface that is used for connecting the display to the management server 200. The display I/F 47 displays the data of the management server 200 on the display.

The CPU 41 collects log information that represents the operation states of the MFPs as the operation information from the MFPs 101 to 10n on a regular basis by communicating with the MFPs 101 to 10n through the network I/F 44. In other words, the network I/F 44 is an information collecting unit that collects the log information representing the operation states of the MFPs. The CPU 41 causes the storage unit 46 to store the log information described above as the operation information of the MFPs.

The calculation unit 411 of the CPU 41 calculates individual power consumption amounts of the MFPs 101 to 10n for a period set in advance based on the log information that is the operation information of the collected MFPs as above. The setting unit 412 of the CPU 41 compares a reference power consumption amount with the power consumption amounts calculated by the calculation unit 411. The setting unit 412 sets sleep timer values until the MFPs 101 to 10n transit to the power-saving mode based on the result of the comparison for the plurality of MFPs 101 to 10n. The management unit 413 of the CPU 41 manages the power consumption amounts of the MFPs 101 to 10n by transmitting the sleep timer values set by the setting unit 412 to the corresponding MFPs 101 to 10n through the network 300. The sleep timer values described above will be described later.

The MFPs 101 to 10n transmit the log information described above to the management server 200 based on a request from the management server 200. The log information, as described above, is information that represents the use statuses of the MFPs 101 to 10n. The management server 200, for example, acquires an operation (copy, print, FAX, or the like) performed by each of the MFPs 101 to 10n, a time when the operation is performed, and the number of times the operation is performed based on the log information. The management server 200 collects the log information and stores the collected log information in the storage unit 46 of each MFP, thereby accumulating the log information.

Hereinafter, an operation of the MFP 101 performed in the power-saving mode and an operation of returning to a normal mode will be described. There are cases where, even when a predetermined time elapses after the process of the MFP 101 such as a printing process according to the reception of a user's operation in the operation unit 13, the operation unit 13 may not receive a user's operation. In a case where the operation unit 13 has not received a user's operation even when the predetermined time elapses, the power supply control unit 27 of the MFP 101 turns off the conduction of the scanner 14, the printer 15, and the like. By turning off the conduction of each unit, the power supply control unit 27 sets each unit of the MFP 101 to be in a sleep state that is the power-saving mode. Next, when the operation unit 13 receives a user's operation, the power supply control unit 27 turns on the conduction of each unit, thereby returning each unit of the MFP 101 from the power-saving mode to a normal operation mode. In description presented below, a predetermined elapse time until the transition to the power-saving mode (sleep state or the like) is made after the operation unit 13 receives a user's operation for the last time will be referred to as a sleep timer value.

In the power-saving mode, the power supply control unit 27 of the MFP 101, for example, turns off the back light disposed inside the operation unit 13, thereby setting the operation unit 13 to be in the sleep state. Next, when the operation unit 13 receives a user's operation, the power supply control unit 27 turns on the back light, thereby returning the operation unit 13 to be in a normal operating state. In addition, by turning off the conduction of the scanner 14 and the printer 15, the power supply control unit 27 sets the scanner 14 and the printer 15 to be in the sleep state. Next, when the operation unit 13 receives a user's operation, the power supply control unit 27 turns on the conduction of the scanner 14 and the printer 15. By turning on the conduction of the scanner 14 and the printer 15, the power supply control unit 27 returns the scanner 14 and the printer 15 to be in a state in which a scanning operation or a printing operation can be performed.

Furthermore, in the power-saving mode, the power supply control unit 27 of the MFP 101 sets the fixing unit to be in a turned-off state or a low-temperature state as the sleep state. For example, in the low-temperature state, the power supply control unit 27 performs control such that a temperature setting of the fixing unit is lower than a normal temperature setting. More specifically, in the low-temperature state, the power supply control unit 27 performs control such that the temperature of the fixing unit is maintained to be a temperature which is lower than a normal temperature and from which the temperature of the normal state can be returned within several tens of seconds. When the fixing unit is in the turned-off state, it takes a time for the fixing unit to return to the normal state. In contrast to this, by setting the fixing unit to be in the low-temperature state, a time required for returning to the normal state can be shortened. By setting the fixing unit to be in the low-temperature state, the power consumption can be reduced compared with the time of a normal operation.

In addition, in the power-saving mode, the power supply control unit 27 may set the FAX control unit 33 to be in the sleep state. However, there is a possibility that the MFP receives a fax at night. Thus, the power supply control unit 27 is not supposed to completely turn off the conduction of the FAX control unit 33. Accordingly, the power supply control unit 27 at least sets the interface (I/F) 34 for the line to be in the turned-on state, so that the FAX control unit 33 is operable in a case where there is reception from the line.

Furthermore, in the power-saving mode, the CPU 21 may transit to the sleep state. When the CPU 21 transits to the sleep state, the CPU 21, for example, stops the execution of a command in each unit of the MFP and the supply of a clock signal to each unit of the MFP. The sleep state of the CPU 21 is returned to the normal state, for example, in a case where an interrupt signal set in advance is input to the CPU 21 from the outside. More specifically, the CPU 21 monitors whether a user's operation is present in the operation unit 13. In addition, the CPU 21 monitors the reception state of a signal in the network I/F 24 and the FAX control unit 33. When the operation unit 13 receives a user's operation, when the network I/F 24 receives a signal, or when the FAX control unit 33 receives a signal, the CPU 21 receives an interrupt signal from the operation unit 13, the network I/F 24, or the FAX control unit 33. When the interrupt signal is received, the CPU 21 is returned to the normal mode. In the power-saving mode, the application is not limited to the examples described above, and the other units of the MFP 101 may be set to be in the sleep state or the ready state.

According to the first embodiment, the management server 200 that is the management apparatus of the image forming apparatuses acquires and stores the log information that is the operation information of the MFPs 101 to 10n and sets the sleep timer values of the MFPs 101 to 10n based on the log information. More specifically, the management server 200 acquires individual power consumption amounts of the MFPs 101 to 10n based on the log information of the MFPs 101 to 10n. The management server 200 compares the acquired individual power consumption amounts of the MFPs with the individual power consumption amounts of the MFPs of the past. The management server 200 acquires sleep timer values of the MFPs 101 to 10n based on the result of the comparison. The management server 200 sets the acquired sleep timer values to the MFPs 101 to 10n. The management server 200 transmits the set sleep timer values to the corresponding MFPs 101 to 10n. In other words, the management server 200 applies the set sleep timer values to the plurality of the MFPs 101 to 10n. By applying the sleep timer values to the MFPs 101 to 10n, the management server 200 manages the power amounts of the MFPs 101 to 10n. In addition, the management server 200, as will be described later, may individually adjust the sleep timer values in accordance with the use statuses of the MFPs 101 to 10n.

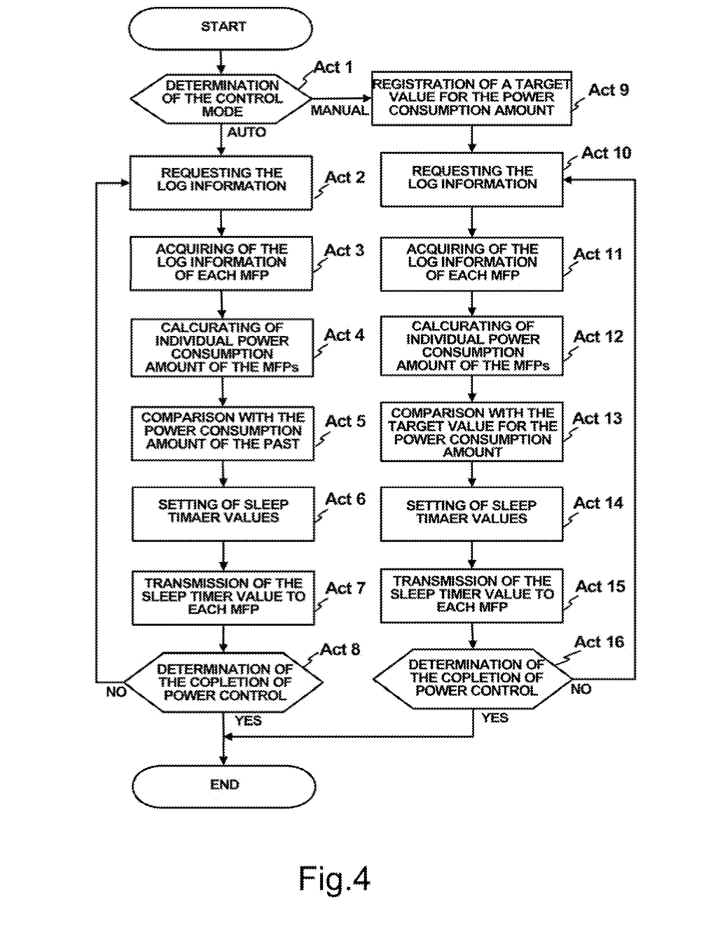

Hereinafter, the operation of the management server 200 for the power management of the MFPs will be described with reference to FIG. 4. FIG. 4 is a flowchart that illustrates the power management operation of the management server 200. The management server 200 performs power management of the MFPs by executing the program stored in the ROM 43 under the control of the CPU 41.

The management server 200 has an automatic mode and a manual mode as power control modes. As illustrated in FIG. 4, in Act 1, the CPU 41 of the management server 200 determines whether the power control mode is the automatic mode or the manual mode. The automatic mode or the manual mode is set by inputting a command corresponding to a user's operation from the input unit 45 of the management server 200.

In a case where the power control mode is determined to be the automatic mode by the CPU 41 (“AUTO” in the Act 1), the process of the power management operation proceeds to Act 2. In Act 2, the CPU 41 requests the operation information from the MFPs 101 to 10n through the network 300. The operation information, as described above, includes information that represents the use statuses of the MFPs. The information representing the use status includes information from which an operation (copy, print, FAX, or the like) performed by the MFP, a time when the operation is performed, and the number of times the operation is performed can be acquired. The operation information, for example, is log information that represents the operation state of each MFP. In the following description, the operation information will be described as the log information. When a request for the log information is received from the management server 200, the CPU 21 of each of the MFPs 101 to 10n transmits the log information to the management server 200 through the network 300. In Act 3, the CPU 41 acquires the log information from each of the MFPs 101 to 10n. More specifically, the CPU 41 acquires the log information through the network I/F 44 that is an information collecting unit.

In Act 4, the calculation unit 411 of the CPU 41 acquires individual power consumption amounts of the MFPs 101 to 10n based on the acquired log information. These acquired power consumption amounts are individual power consumption amounts of the MFPs 101 to 10n for a period set in advance and are total consumption amounts of the individual MFPs for the period set in advance. Hereinafter, this period set in advance will be referred to as a calculation period. The calculation period, for example, is designated by a user from among a plurality of predetermined periods such as one week and one month. More specifically, as the input unit 45 receives a user's operation, the calculation period is designated. In other words, the calculation unit 411 acquires a total power consumption amount for the calculation period designated by the user for each of the MFPs 101 to 10n. In Act 5, the setting unit 412 of the CPU 41 compares the individual power consumption amounts (consumption data of the power amount) of the MFPs 101 to 10n of the past with the individual power consumption amounts of the MFPs 101 to 10n which have been calculated in Act 4. In other words, the setting unit 412 sets the power consumption amounts of the past as reference power consumption amounts used for the comparison. For example, in a case where the calculation period of the calculated power consumption amount is for one month that is a target month, the reference power consumption amount may be the power consumption amount (consumption data of the power amount) of the previous month of the target month. Similarly, in a case where the calculation period of the calculated power consumption amount is for one month that is a target month, the reference power consumption amount may be the power consumption amount of the same month of the previous year. A specific time point in the past at which the power consumption amount is set as the reference power consumption amount is set by a user in advance. More specifically, as the input unit 45 receives a user's operation, a specific time point in the past at which the power consumption amount is set as the reference power consumption amount is set.

In Act 6, the setting unit 412 of the CPU 41 sets the sleep timer values based on the result of the comparison that has been acquired in Act 5. The setting unit 412 acquires each sleep timer value such that the individual power consumption amount of each MFP, which has been calculated as above, is the individual reference power consumption amount of the MFP or less. For example, as the result of the comparison, in each MFP, in a case where the calculated power consumption amount of this month (the target month described above) is larger than the power consumption amount (the reference power consumption amount) of the previous month of the target month, the setting unit 412 sets the sleep timer value to a small timer value. This small timer value, for example, is a timer value that is determined in advance in accordance with the increased power consumption amount. By changing the sleep timer value to the small timer value described above, a time for a transition from the normal mode to the power-saving mode that is in the sleep state is shortened. Accordingly, the power consumption of the MFP is saved. As another example, as the result of the comparison, in each MFP, in a case where the calculated power consumption amount of this month (the target month described above) is smaller than the power consumption amount (the reference power consumption amount) of the previous month of the target month, the setting unit 412 sets the sleep timer value to a large timer value. This large timer value, for example, is a timer value that is determined in advance in accordance with the decreased power consumption amount. Accordingly, the setting unit 412 can adjust the sleep timer value such that the individual power consumption amount of each MFP, which has been acquired as above, does not exceed the reference power consumption amount of the MFP. In a case where there is a sleep timer value that is set in advance, the setting unit 412 changes this sleep timer value set in advance to the sleep timer value acquired based on the result of the comparison, thereby setting the sleep timer value.

In addition, the operating status of the MFP also changes in accordance with the season or the like. Accordingly, there are also cases where it is better to compare the power consumption amount of the same month of the previous year as the target month and the power consumption amount acquired as above with each other than to simply compare the power consumption amount (the consumption data of the power amount) of the previous month of the target month and the power consumption amount acquired as above with each other. In addition, as described above, the calculation period may be a week. For example, as the result of the comparison, there are cases where the power consumption amount of this week (target week) is larger than the power consumption amount of the previous week of the target week for which the power consumption amount has been acquired. In such cases, the setting unit 412 may change the sleep timer value to the small timer value.

Furthermore, in Act 6, the setting unit 412 of the CPU 41 acquires a use frequency indicating an MFP of which the number of times of use is the highest (or the lowest) at the current time point based on the log information of the MFPs 101 to 10n. The setting unit 412 may be configured to correct the sleep timer values of the MFPs 101 to 10n, which have been acquired based on the result of the comparison in Act 5, based on the content of the use frequency acquired as above. In such a case, the setting unit 412 assigns the corrected sleep timer values to the MFPs 101 to 10n. For example, the setting unit 412 corrects the sleep timer value of the MFP of which the number of times of use is high to a sleep timer value that is larger than the sleep timer value calculated as above. This larger timer value, for example, is a timer value that is determined in advance in accordance with the number of high frequency of use. In addition, the setting unit. 412 corrects the sleep timer value of the MFP of which the number of times of use is low to a sleep timer value that is smaller than the sleep timer value calculated as above. This smaller timer value, for example, is a timer value that is determined in advance in accordance with the number of low frequency of use.

When the MFP is returned from the power-saving mode that is in the sleep state to the normal mode, it takes a predetermined time. Thus, when the sleep timer value of the MFP of which the number of times of use is large is set to be small, the MFP becomes frequently in the sleep state. When the MFP becomes frequently in the sleep state, a user's waiting time increases. When the user's waiting time increases, it causes a trouble when the user performs a copying operation or a printing operation using the MFP. To the contrary, even when the sleep timer value of the MFP of which the number of times of use is small is set to be small, the use frequency is low, and accordingly, there is much less trouble to the user. Accordingly, for example, it is meaningful to perform switching the sleep timer values between the MFP that is disposed in a section in which the number of times of use of the MFP is large and the MFP that is disposed in a section in which the number of times of use is small.

In Act 7, the management unit 413 of the CPU 41 sends the sleep timer values set by the setting unit 412 to the corresponding MFPs through the network I/F 44. In each of the MFPs 101 to 10n, the power supply control unit 27 sets a power-saving mode based on the sleep timer value received from the management server 200. In Act 8, the CPU 41 of the management server 200 determines whether or not the program of the power management has ended. In a case where the program of the power management is determined not to have ended by the CPU 41 (No in the Act 8), the management server 200 repeats the operations of Acts 2 to 8 at a predetermined interval. On the other hand, in a case where the program of the power management is determined to have ended by the CPU 41 (Yes in the Act 8), the management server 200 ends the process for the power management.

On the other hand, in a case where the power control mode is determined to be the manual mode by the CPU 41 (“MANUAL” in the Act 1), the operation of the power management proceeds to Act 9. In Act 9, the CPU 41 registers a target value for the power consumption amount that is input by the user using the input unit 45. More specifically, the input unit 45 receives a user's operation, thereby inputting the target value for the power consumption amount. The CPU 41 registers the target value for the power consumption amount that has been received by the input unit 45.

In Act 10, the CPU 41 requests the log information from each of the MFPs 101 to 10n through the network 300. When the request for the log information is received from the management server 200, the CPU 21 of each of the MFPs 101 to 10n transmits the log information to the management server 200 through the network 300. In Act 11, the CPU 41 acquires the log information from each of the MFPs 101 to 10n through the network I/F 44.

In Act 12, the calculation unit 411 of the CPU 41 acquires individual power consumption amounts of the MFPs 101 to 10n based on the acquired log information. These acquired power consumption amounts, similar to Act 4, are power consumption amounts for the calculation period designated by the user. In Act 13, the setting unit 412 of the CPU 41 compares the target value with the calculation result. More specifically, the setting unit 412 sets the target value for the power consumption amount received by the input unit as the reference power consumption amount used for the comparison. The setting unit 412 compares the reference power consumption amount with the power consumption amounts acquired in Act 12. In Act 14, the setting unit 412 of the CPU 41 sets the sleep timer values based on the result of the comparison acquired in Act 13. More specifically, the setting unit 412, similar to Act 6, acquires the sleep timer values. In addition, the setting unit 412, similar to Act 6, sets the sleep timer values.

For example, as the result of the comparison performed in Act 13, in a case where the power consumption amount acquired as above is larger than the target value, the setting unit 412 sets the sleep timer value to the small timer value. By decreasing the sleep timer value, a time for a transition from the normal mode to the power-saving mode that is in the sleep state is shortened. Accordingly, the power consumption of the MFP is saved. As another example, in a case where the acquired power consumption amount is smaller than the target value, the setting unit 412 sets the sleep timer value to the large timer value. Accordingly, the setting unit 412 can adjust the sleep timer value such that the power consumption amount does not exceed the target value for the power consumption amount that is set by the user.

In addition, in Act 14, the setting unit 412 of the CPU 41 acquires a use frequency indicating an MFP of which the number of times of use is large (or small) at the current time point based on the log information of the MFPs 101 to 10n. The setting unit 412 corrects the sleep timer values of the MFPs 101 to 10n, which have been calculated as above, based on the content of the use frequency acquired as above. The setting unit 412 assigns the corrected sleep timer values to the MFPs 101 to 10n. For example, the setting unit 412 corrects the sleep timer value of the MFP of which the number of times of use is large to a sleep timer value (see Act 6) that is larger than the sleep timer value calculated as above within the allowed range. In addition, the setting unit 412 corrects the sleep timer value of the MFP of which the number of times of use is low to a sleep timer value (see Act 6) that is smaller than the sleep timer value calculated as above. As described above, even when the sleep timer value of the MFP of which the number of times of use is small is set to be small, the use frequency is low, and accordingly, there is much less trouble to the user.

In Act 15, the management unit 413 of the CPU 41 sends the sleep timer values set by the setting unit 412 to the MFPs through the network I/F 44. In each of the MFPs 101 to 10n, the power supply control unit 27 sets a power-saving mode based on the sleep timer value received from the management server 200. In Act 16, the CPU 41 of the management server 200 determines whether or not the program of the power management has ended. In a case where the program of the power management is determined not to have ended by the CPU 41 (No in the Act 16), the management server 200 repeats the operations of Acts 10 to 16 at a predetermined interval. On the other hand, in a case where the program of the power management is determined to have ended by the CPU 41 (Yes in the Act 16), the management server 200 ends the process for the power management.

As described above, according to the management apparatus of image forming apparatuses according to the first embodiment, the power consumption amounts of a plurality of the imago forming apparatuses can be integrally managed. In addition, the management apparatus of image forming apparatuses according to the first embodiment individually adjusts a time at which a transition to the power-saving mode (for example, the sleep state) is made based on the data of the past power consumption amount used as the reference. Therefore, according to the management apparatus of image forming apparatuses according to the first embodiment, the power consumption amounts of a plurality of the image forming apparatuses can be integrally reduced. Furthermore, according to the management apparatus of image forming apparatuses according to the first embodiment, a time at which a transition to the power-saving mode is made can be adjusted such that the power consumption amount does not exceed the target value for the power consumption amount that is set by the user.

In Act 5 illustrated in FIG. 4, while the setting unit 412 compares the data of the past power consumption amount with the power consumption amount calculated by the calculation unit 411, a time point of the “past” that is the reference for the comparison may be arbitrarily set by the user. The “past” that is the reference for the comparison is arbitrary, for example, one year before, one month before, or one week before the target period for the calculation.

Hereinafter, a management apparatus of image forming apparatuses according to a second embodiment will be described. The power management apparatus of image forming apparatuses according to the second embodiment has the above-described configuration illustrated in FIGS. 1 to 3. Accordingly, in the following description, parts of the management apparatus of image forming apparatuses according to the second embodiment, which are different from those of the first embodiment, will be described.

According to the second embodiment, a management server 200 that is the management apparatus of image forming apparatuses acquires and stores log information that is the operation information of MFPs 101 to 10n and sets the sleep timer values of the MFPs 101 to 10n based on the log information. More specifically, a calculation unit 411 of the management server 200 calculates a total power consumption amount acquired by summing the individual power consumption amounts of the MFPs 101 to 10n based on the log information of the MFPs 101 to 10n. A setting unit 412 of the management server 200 compares the calculated total power consumption amount with a total power consumption amount of the MFPs 101 to 10n of the past. The setting unit 412 sets a first sleep timer value based on a result of the comparison. In addition, the setting unit 412 of the management server 200 sets a second sleep timer value based on the first sleep timer value. More specifically, the setting unit 412 acquires individual use statuses (for example, use frequencies) of the MFPs 101 to 10n based on the log information of the MFPs 101 to 10n. The setting unit 412 of the management server 200 corrects the first sleep timer value based on the acquired individual use statuses of the MFPs 101 to 10n, thereby acquiring a second sleep timer value that is the sleep timer value of each of the MFPs 101 to 10n. The management server 200 sets the acquired second sleep timer value for each of the MFPs 101 to 10n. In other words, the management server 200 applies the second sleep timer value that has been set to a plurality of the MFPs 101 to 10n. The management server 200 applies the second sleep timer value to the MFPs 101 to 10n, thereby managing the power amounts of the MFPs 101 to 10n.

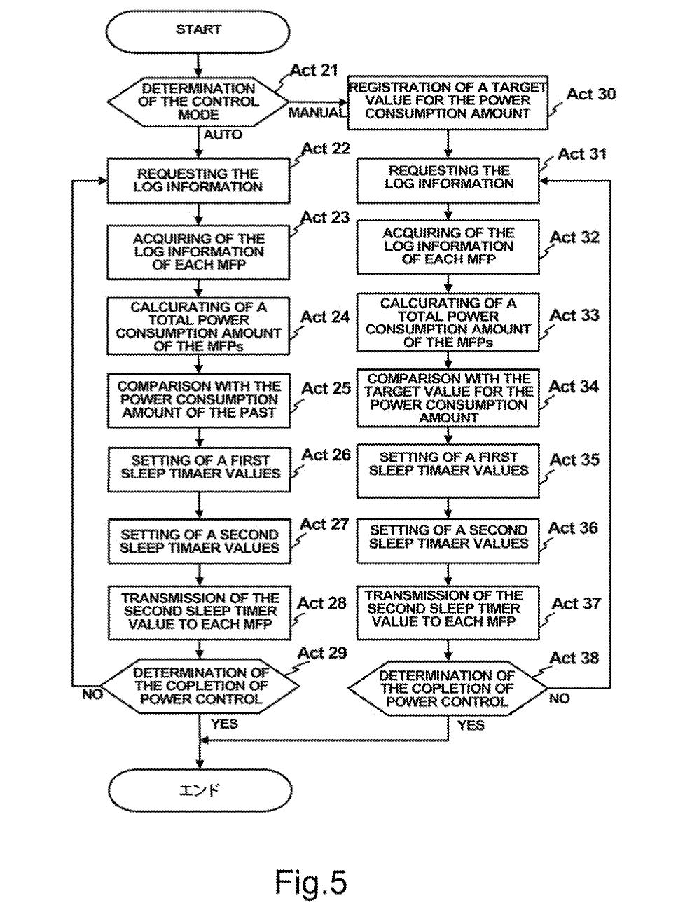

Hereinafter, the power management operation of the MFP of the management server 200 according to the second embodiment will be described with reference to FIG. 5. FIG. 5 is a flowchart that illustrates the power management operation of the management server 200. The management server 200 executes a program stored in a ROM 43 under the control of the CPU 41, thereby performing power management of the MFP.

The management server 200 has an automatic mode and a manual mode as power control modes. As illustrated in FIG. 5, in Act 21, the CPU 41 of the management server 200 determines whether the power control mode is the automatic mode or the manual mode. The automatic mode or the manual mode is set by inputting a command corresponding to a user's operation from the input unit 45 of the management server 200.

In a case where the power control mode is determined to be the automatic mode by the CPU 41 (“AUTO” in the Act 21), the process of the power management operation proceeds to Act 22. In Act 22, the CPU 41 requests the operation information from the MFPs 101 to 10n through the network 300. The operation information, as described above, includes information that represents the use statuses of the MFPs. The information representing the use status includes information from which an operation (copy, print, FAX, or the like) performed by the MFP, a time when the operation is performed, and the number of times the operation is performed can be acquired. The operation information, for example, is log information that represents the operation state of the MFP. In the following description, the operation information will be described as the log information. When a request for the log information is received from the management server 200, the CPU 21 of each of the MFPs 101 to 10n transmits the log information to the management server 200 through the network 300. In Act 23, the CPU 41 acquires the log information from each of the MFPs 101 to 10n. Here specifically, the CPU 41 acquires the log information through the network I/F 44. Accordingly, the network I/F 44 is an information collecting unit that is used for acquiring the log information from the MFPs 101 to 10n through the network I/F 44.

In Act 24, the calculation unit 411 of the CPU 41 acquires individual power consumption amounts of the MFPs 101 to 10n based on the acquired log information. The calculation unit 411 sums the acquired individual power consumption amounts of the MFPs 101 to 10n, thereby calculating a total power consumption amount of the MFPs 101 to 10n. This calculated total power consumption amount is a total power consumption amount of the MFPs 101 to 10n for a period set in advance. Hereinafter, this period set in advance will be referred to as a calculation period. The calculation period, for example, is designated by a user from among a plurality of predetermined periods such as one week and one month. More specifically, as the input unit 45 receives a user's operation, the calculation period is designated. In other words, the calculation unit 411 sums the power consumption amounts of the MFPs 101 to 10n, thereby calculating the total power consumption amount for the calculation period designated by the user. In Act 25, the setting unit 412 of the CPU 41 compares the total power consumption amount (total consumption data of the power amount) of the MFPs 101 to 10n of the past with the total power consumption amount which has been calculated in Act 24. In other words, the setting unit 412 sets the total power consumption amount of the MFPs 101 to 10n of the past as reference total power consumption amount used for the comparison. For example, in a case where the calculation period of the calculated total power consumption amount is for one month that is a target month, the reference total power consumption amount may be a total power consumption, amount of the previous month of the target month of the MFPs 101 to 10n. Similarly, in a case where the calculation period of the calculated total power consumption amount is for one month that is a target month, the reference total power consumption amount may be the total power consumption amount of the same month of the previous year. A specific time point in the past at which the total power consumption amount is set as the reference total power consumption amount is set by a user in advance. More specifically, as the input unit 45 receives a user's operation, a specific time point in the past at which the total power consumption amount is set as the reference total power consumption amount is set.

In Act 26, the setting unit 412 of the CPU 41 sets the first sleep timer value based on the result of the comparison that has been acquired in Act 25. More specifically, the setting unit 412 sets the first sleep timer value such that the total power consumption amount, which has been calculated as above, is the reference total power consumption amount or less. For example, as the result of the comparison, in a case where the calculated total power consumption amount of this month (the target month described above) is larger than the total power consumption amount (the reference total power consumption amount) of the previous month of the target month, the setting unit 412 sets the first sleep timer value to a small timer value. This small timer value, for example, is a timer value that is determined in advance in accordance with the increased amount. As another example, as the result of the comparison, in a case where the calculated total power consumption amount of this month (the target month described above) is smaller than the total power consumption amount (the reference total, power consumption amount) of the previous month of the target month, the setting unit 412 sets the first sleep timer value to a large timer value. This large timer value, for example, is a timer value that is determined in advance in accordance with the decreased amount. Accordingly, the setting unit 412 can adjust the first sleep timer value such that the total power consumption amount, which has been calculated as above, does not exceed the reference total power consumption amount. In a case where there is a first sleep timer value that is set in advance, the setting unit 412 changes this first sleep timer value set in advance to the first sleep timer value acquired based on the result of the comparison, thereby setting the first sleep timer value.

In addition, the operating status of the MFP also changes in accordance with the season or the like. Accordingly, there are also cases where it is better to compare the total power consumption amount (the total consumption data of the power amount) of the same month of the previous year as the target month and the total power consumption amount calculated as above with each other than to simply compare the total power consumption amount of the previous month of the target month and the total power consumption amount calculated as above with each other. In addition, as described above, the calculation period may be a week. For example, as the result of the comparison, there are cases where the total power consumption amount of this week (target week) is larger than the total consumption data of the power amount of the previous week of the target week for which the total power consumption amount has been calculated. In such cases, the setting unit 412 may change the first sleep timer value to the small timer value.

Furthermore, in Act 27, the setting unit 412 of the CPU 41 sets the second sleep timer value based on the first sleep timer value. For example, the setting unit 412 acquires the use statuses of the MFPs 101 to 10n for the calculation period described above based on the log information of the MFPs 101 to 10n. The use status, for example, is a use frequency. In the following description, although the use status will be described as the use frequency, the use status is not limited to the use frequency. The setting unit 412 corrects the first sleep timer value set in Act 26 based on the content of the acquired use frequency, thereby acquiring a second sleep timer value that is a sleep timer value for each of the MFPs 101 to 10n. In addition, the setting unit 412 acquires the second sleep timer value such that the total power consumption amount of the MFPs 101 to 10n, which has been calculated as above, is the reference total power consumption amount or less. For example, the setting unit 412 sets the second sleep timer value of the MFP having a high use frequency to a timer value larger than the first sleep timer value and sets the second sleep timer value of the MFP having a low use frequency to a timer value that is smaller than the first sleep timer value. The larger timer value, for example, is a timer value that is determined in advance in accordance with a high use frequency. In addition, the smaller timer value, for example, is a timer value that is determined in advance in accordance with a low use frequency. In a case where there is the second sleep timer value set in advance, the setting unit 412 changes the second sleep timer value set in advance to the acquired second sleep timer value, thereby setting the second sleep timer value. The setting unit 412 sets the second sleep timer value, thereby assigning the second sleep timer value to each of the MFPs 101 to 10n.

As described above, when the MFP is returned from the power-saving mode that is in the sleep state to the normal mode, it takes a predetermined time. Thus, when the second sleep timer value of the MFP of which the use frequency is high (the number of times of use is large) is set to be small, the MFP becomes frequently in the sleep state. When the MFP is frequently in the sleep state, a user's waiting time increases. When the user's waiting time increases, it causes a trouble when the user performs a copying operation or a printing operation using the MFP. To the contrary, even when the sleep timer value of the MFP of which the use frequency is low (the number of times of use is small) is set to be small, the use frequency is low, and accordingly, there is much less trouble to the user. Accordingly, for example, it is meaningful to perform switching the second sleep timer values between the MFP that is disposed in a section in which the use frequency of the MFP is high and the MFP that is disposed in a section in which the use frequency is low.

In Act 28, the management unit 413 of the CPU 41 sends the second sleep timer values set by the setting unit 412 to the corresponding MFPs through the network I/F 44. In each of the MFPs 101 to 10n, the power supply control unit 27 sets the power-saving mode based on the second sleep timer value received from the management server 200. In Act 29, the CPU 41 of the management server 200 determines whether or not the program of the power management has ended. In a case where the program of the power management is determined not to have ended by the CPU 41 (No in the Act 29), the management server 200 repeats the operations of Acts 22 to 29 at a predetermined interval. On the other hand, in a case where the program of the power management is determined to have ended by the CPU 41 (Yes in the Act 29), the management server 200 ends the process for the power management.

On the other hand, in a case where the power control mode is determined to be the manual mode by the CPU 41 (“MANUAL” in the Act 21), the process of the power management operation proceeds to Act 30. In Act 30, the CPU 41 registers a target value for the total power consumption amount that is input by the user using the input unit 45. More specifically, the input unit 45 receives a user's operation, thereby inputting the target value for the total power consumption amount. The CPU 41 registers the target value for the total power consumption amount that has been received by the input unit 45.

In Act 31, the CPU 41 requests the log information, which is the operation information of the MFP, from each of the MFPs 101 to 10n through the network 300. When the request for the log information is received from the management server 200, the CPU 21 of each of the MFPs 101 to 10n transmits the log information to the management server 200 through the network 300. In Act 32, the CPU 41 acquires the log information from each of the MFPs 101 to 10n through the network I/F 44.

In Act 33, the calculation unit 411 of the CPU 41 acquires individual power consumption amounts of the MFPs 101 to 10n based on the acquired log information. The calculation unit 411, similar to Act 24, sums the acquired individual power consumption amounts of the MFPs 101 to 10n, thereby calculating a total power consumption amount of the MFPs 101 to 10n for the calculation period designated by the user. In Act 34, the setting unit 412 of the CPU 41 compares the total power consumption amount that is the target value with the acquired total power consumption amounts of the MFPs 101 to 10n. More specifically, the setting unit 412 sets the target value for the total power consumption amount received by the input unit as the reference total power consumption amount used for the comparison. The setting unit 412 compares the reference total power consumption amount with the power consumption amount calculated in Act 33. In Act 35, the setting unit 412 of the CPU 41 sets the first sleep timer value based on the result of the comparison acquired in Act 34. More specifically, the setting unit 412, similar to Act 26, acquires the first sleep timer value such that the calculated total power consumption amount is equal to or less than the total power consumption amount that is the target value.

For example, as the result of the comparison performed in Act 34, in a case where the total power consumption amount calculated as above is larger than the total power consumption amount that is the target value, the setting unit 412 sets the first sleep timer value to the small timer value (see Act 26). On the other hand, in a case where the calculated total power consumption amount is smaller than the total power consumption amount that is the target value, the setting unit 412 sets the first sleep timer value to the large timer value (see Act 26). Accordingly, the setting unit 412 can adjust the first sleep timer value such that the total power consumption amount does not exceed the target value for the total power consumption amount that is set by the user. In a case where there is the first sleep timer value set in advance, the setting unit 412 changes this first sleep timer value set in advance to the first sleep timer value acquired based on the result of the comparison, thereby setting the first sleep timer value.

Furthermore, in Act 36, the setting unit 412 of the CPU 41 sets the second sleep timer value based on the first sleep timer value. For example, the setting unit 412, similar to Act 27, acquires the use frequencies for the calculation period described above based on the log information of the MFPs 101 to 10n. The setting unit 412 corrects the first sleep timer value set in Act 35 based on the content of the acquired use frequency, thereby acquiring a second sleep timer value for each of the MFPs 101 to 10n. In addition, the setting unit 412 acquires the second sleep timer value such that the total power consumption amount of the MFPs 101 to 10n, which has been calculated as above, is equal to or less than the total power consumption amount that is the target value. For example, the setting unit 412 sets the second sleep timer value of the MFP having a high use frequency to a timer value (see Act 27) larger than the first sleep timer value and sets the second sleep timer value of the MFP having a low use frequency to a timer value (see Act 27) that is smaller than the first sleep timer value. In a case where there is the second sleep timer value set in advance, the setting unit 412 changes this second sleep timer value set in advance to the acquired second sleep timer value, thereby setting the second sleep timer value. The setting unit 412 sets the second sleep timer value, thereby assigning the second sleep timer value to each of the MFPs 101 to 10n.

In Act 37, the management unit 413 of the CPU 41 sends the second sleep timer values set by the setting unit 412 to the MFPs through the network I/F 44. In each of the MFPs 101 to 10n, the power supply control unit 27 sets the power-saving mode based on the second sleep timer value received from the management server 200. In Act 38, the CPU 41 of the management server 200 determines whether or not the program of the power management has ended. In a case where the program of the power management is determined not to have ended by the CPU 41 (No in the Act 38), the management server 200 repeats the operations of Acts 31 to 38 at a predetermined interval. On the other hand, in a case where the program of the power management is determined to have ended by the CPU 41 (Yes in the Act 38), the management server 200 ends the process for the power management.

As described above, the management apparatus of image forming apparatuses according to the second embodiment sets the first sleep timer value based on the total power consumption amount of the MFPs 101 to 101n and sets the second sleep timer values that are sleep timer values for the MFPs 101 to 101n based on the first sleep timer value. However, the management apparatus of image forming apparatuses according to the second embodiment is not limited thereto. For example, the management apparatus of image forming apparatuses according to the second embodiment may be configured to set the first sleep timer value based, on the total power consumption amount of the MFPs 101 to 101n and set this first timer value as the sleep timer value for each of the MFPs 101 to 101n. In such a case, in the power management operation, the process of Acts 27 and 36 is omitted. In addition, the management unit 413 of the management server 200, in Acts 28 and 37, sends the first sleep time value to the MFPs 101 to 101n.

As described above, according to the management apparatus of image forming apparatuses according to the second embodiment, the power consumption amounts of a plurality of the image forming apparatuses can be integrally managed. In addition, the management apparatus of image forming apparatuses according to the second embodiment individually adjusts a time at which a transition to the power-saving mode (for example, the sleep state) is made based on the data of the past power consumption amount used as the reference. Therefore, according to the management apparatus of image forming apparatuses according to the second embodiment, the power consumption amounts of a plurality of the image forming apparatuses can be integrally reduced. Furthermore, according to the management apparatus of image forming apparatuses according to the second embodiment, a time at which a transition to the power-saving mode is made can be adjusted such that the power consumption amount does not exceed the target value for the power consumption amount that is set by the user.

In Act 25 illustrated in FIG. 5, while the setting unit 412 compares the data of the past power consumption amount with the power consumption amount calculated by the calculation unit 411, a time point of the “past” that is the reference for the comparison may be arbitrarily set by the user. The “past” that is used as the reference for the comparison such as one year before, one month before, or one week before the target period for the calculation, is arbitrary.

In the embodiments described above, the case has been described in which the functions for operating the image forming apparatus and the management apparatus of image forming apparatuses are recorded in the image forming apparatus and the management apparatus of image forming apparatuses in advance. However, an embodiment is not limited thereto, but the same functions may be downloaded from a network to the image processing apparatus, or the same functions stored on a recording medium may be installed to the apparatus. As the recording medium, a recording medium such as a CD-ROM capable of storing a program that can be read by the image forming apparatus and the management apparatus of image forming apparatuses may be used regardless of the form. The functions acquired through pre-installation or download may be realized in cooperation with the operating system (OS) prepared inside the image processing apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A management apparatus of image forming apparatuses, the management apparatus comprising:
an information collecting unit configured to collect a plurality of pieces of log information that represent operation states of a plurality of the image forming apparatuses through a network;
a calculation unit configured to calculate power consumption amounts of the image forming apparatuses for a period set in advance based on the collected log information;
a setting unit configured to compare reference power consumption amounts with the calculated power consumption amounts and set a sleep timer value that is a predetermined elapse time until the image forming apparatus transits to a power-saving mode after an operation unit of the image forming apparatus receives a user's operation for the last time to each of the plurality of the image forming apparatuses based on a result of the comparison; and
a management unit configured to respectively transmit the sleep timer values set by the setting unit to the corresponding image forming apparatuses through the network.

2. The management apparatus of the image forming apparatuses according to claim 1, wherein the setting unit sets data of past power consumption amounts for a period set in advance as the reference power consumption amounts and sets the sleep timer values by comparing the reference power consumption amounts with the calculated power consumption amounts.

3. The management apparatus of the image forming apparatuses according to claim 1, the management apparatus further comprising an input unit configured to input target values for the power consumption amounts by receiving a user's operation,
wherein the setting unit sets the target values for the power consumption amounts input by the input unit as the reference power consumption amounts and sets the sleep timer values by comparing the reference power consumption amounts with the calculated power consumption amounts.

4. The management apparatus of the image forming apparatuses according to claim 1, wherein the setting unit acquires use frequencies of the plurality of the image forming apparatuses from the log information and corrects the sleep timer values of the image forming apparatuses based on the content that is acquired.

5. The management apparatus of the image forming apparatuses according to claim 4, wherein the setting unit, based on the content of the acquired use frequencies, corrects the sleep timer value of the image forming apparatus of which the use frequency is high to a sleep timer value larger than, the set sleep timer value and corrects the sleep timer value of the image forming apparatus of which the use frequency is low to a sleep timer value smaller than the set sleep timer value.

6. The management apparatus of the image forming apparatuses according to claim 1, the management apparatus further comprising a storage unit configured to store the log information of the plurality of the image forming apparatuses that is collected through the network.

7. A method of managing image forming apparatuses for managing power consumption of a plurality of the image forming apparatuses, the method comprising:
collecting a plurality of pieces of log information that represent operation states of the image forming apparatuses through a network;
calculating power consumption amounts of the image forming apparatuses for a period set in advance based on the collected log information;
comparing reference power consumption amounts with the calculated power consumption amounts;
setting a sleep timer value that is a predetermined elapse time until the image forming apparatus transits to a power-saving mode after an operation unit of the image forming apparatus receives a user's operation for the last time to each of the plurality of the image forming apparatuses; and
respectively transmitting the set sleep timer values to the corresponding image forming apparatuses through the network.

8. An image forming apparatus comprising:
an operation unit configured to receive a user's operation;
a transmission/reception unit configured to transmit log information that represents the operation state of the apparatus to the outside through a network and to receive a sleep timer value that is set based on the log information as a predetermined elapse time until the apparatus transits to a power-saving mode after the operation unit receives a user's operation for the last time from the outside through the network; and
a power supply control unit configured to control a transition to a power-saving mode based on the sleep timer value.

9. The image forming apparatus according to claim 8, wherein the log information includes information from which the use frequency of the apparatus can be acquired.

10. The image forming apparatus according to claim 8, wherein the power supply control unit performs control, such that the predetermined elapse time for the apparatus to transit to the power-saving mode increases based on the sleep timer value in a case where the use frequency of the apparatus is high and performs control such that the predetermined elapse time for the apparatus to transit to the power-saving mode decreases based on the sleep timer value in a case where the use frequency of the apparatus is low.
